(19) United States
(12) Patent Application Publication
(10) Pub. No.: US 2012/0224371 A1
(43) Pub. Date: Sep. 6, 2012

(54) LIGHTING APPARATUS

(75) Inventor: HAN-TSUNG HSUEH, NEW TAIPEI CITY (TW)

(73) Assignees: KINPO ELECTRONICS, INC., New Taipei City (TW); CAL-COMP ELECTRONICS & COMMUNICATIONS COMPANY LIMITED, New Taipei City (TW)

(21) Appl. No.: 13/447,378

(22) Filed: Apr. 16, 2012

Related U.S. Application Data
(63) Continuation-in-part of application No. 13/038,532, filed on Mar. 2, 2011.

(30) Foreign Application Priority Data
Sep. 5, 2011 (TW) 100131915

(51) Int. Cl. F21V 11/00; F21V 21/00

(52) U.S. Cl. 362/235; 362/249.02

(57) ABSTRACT

A lighting apparatus includes a base having a coupling surface, a transparent enclosure mounted on the coupling surface, defining a receiving space, a multi-directional LED housing member disposed on the coupling surface and received in the receiving space. The LED housing member includes a bottom surface coupled to the coupling surface, a plurality of first side-mount surfaces in connection with the bottom surface and a plurality of second side-mount surfaces in connection with the plurality of first side-mount surfaces in a non-coplanar fashion. Furthermore, a light-emitting unit including a plurality of first light-emitting elements respectively mounted on the first side-mount surfaces, and a plurality of second light-emitting elements respectively mounted on the second side-mount surfaces. In addition, the total lumen value of the first light-emitting elements is greater than or equal to that of the second light-emitting devices.

### CROSS-REFERENCE TO RELATED APPLICATION

This application is a continuation-in-part of U.S. application Ser. NO. 13/038,532, filed on Mar. 2, 2011, and entitled “Lighting Apparatus”, now pending, the entire disclosures of which are incorporated herein by reference. This application claims the priority benefit of Taiwan application serial no. 100131915, filed on Sep. 5, 2011. The entirety of above-mentioned patent application hereby incorporated by reference herein and made a part of this specification.

### BACKGROUND OF THE INVENTION

1. Field of the Invention

The present invention relates to a lighting apparatus; in particular, to a lighting apparatus capable of providing even light distribution.

2. Description of Related Art

As Light Emitting Diodes (LED) have advantages such as quick response, energy-saving and are suitable for mass production etc., therefore, researches and developments on LED as lighting apparatus are ongoing unceasingly, bringing rapid growth to the light-relevant market.

LED is an energy-saving lighting device which uses solid-state chips to produce electroluminescence effect. However, as LED is a form of directional light source, the light-emitting characteristic of LED is similar to spotlights, which acts a point light source that projects light toward a specific direction, thus often resulting in uneven illumination and forming dark regions. In this aspect, LED differs greatly from conventional light apparatus (such as fluorescent lights, incandescent or energy-saving light bulbs) which provide even illumination. Thus, conventional LED lighting devices often employ additional optical components (such as reflectors) in the front of the optical axis of the LED to provide modification/adjustment to the illuminating range/pattern. However, the dark portions due to uneven illumination can only be reduced but not completely eliminated. Due to these reasons, lighting apparatus made from LED is conventionally used on partial lighting, such as commerce projections, spotlights, directional lights and etc., remain incapable to apply to offices and homes.

On the other hand, as applications of LED increase rapidly, the UL/CUL and other different countries begin establishing safety regulations on products made from LED, for instance, the safety regulations on three basic product categories are set, such as LED light apparatus, LED light bulbs and LED power supplies, so as to establish a basic direction for manufactures to examine their products; and in the aforementioned regulations, the angle of illumination is also clearly specified in within.

Therefore, increasing the angle of illumination of LED products effectively to meet both the requirements of general applications and safety regulations was deemed the major object of researching.

### SUMMARY OF THE INVENTION

The object of the present invention is to provide a lighting apparatus which can make use of different point sources of light assembled by different groups which has designs of different total lumen values; this enables the directional light sources to achieve even light distribution.

Another object of the present invention is to provide a light apparatus of which the light emitted can meet the requirements of the safety regulations.

In order to achieve the aforementioned objects, according to an embodiment of the present invention, a lighting apparatus is provided, comprising a base having a coupling surface; a transparent enclosure mounted on the coupling surface defining a receiving space, a multi-directional LED housing member disposed on the coupling surface and received in the receiving space; the LED housing member including a bottom surface coupled to the coupling surface, a plurality of first side-mount surfaces in connection with the bottom surface and a plurality of second side-mount surfaces in connection with the plurality of first side-mount surfaces in a non-coplanar fashion; a light-emitting unit including a plurality of first light-emitting elements respectively mounted on the first side-mount surfaces and a plurality of second light-emitting elements respectively mounted on the second side-mount surfaces; wherein the total lumen values of the first light-emitting elements is greater than or equal to that of the second light-emitting elements.

The present invention has the following advantages: the light-emitting elements (the first and the second light-emitting elements) of the light-emitting unit can be mounted on the side surfaces (the first and the second side-mount surfaces) which are in connection with the LED housing member, so as to adjust the total lumen values of the different groups of light-emitting elements; the lighting apparatus can emit even light distribution by adjusting the ratio or the proportion of the total lumen values.

In order to further the understanding regarding the present invention, the following embodiments are provided along with illustrations to facilitate the disclosure of the present invention.

### BRIEF DESCRIPTION OF THE DRAWINGS

FIG. 1 shows a perspective view of a lighting apparatus according to a first embodiment of the present invention.

FIG. 1A shows a side view of a lighting apparatus according to a first embodiment of the present invention.

FIG. 1B shows a test diagram of the light-emitting characteristic of a lighting apparatus according to a first embodiment of the present invention (showing the ratio between the total lumen value of the first and the second light emitting elements, which is 0.78).

FIG. 1C shows a test diagram of the light-emitting characteristic of a lighting apparatus according to a first embodiment of the present invention, (the ratio of the total lumen values is 0.64).

FIG. 2 shows a perspective view of a lighting apparatus according to a second embodiment of the present invention.

FIG. 2A shows a test diagram of the light-emitting characteristic of a lighting apparatus according to a second embodiment of the present invention, (the ratio of the total lumen values is 0.78).

FIG. 2B shows a test diagram of the light-emitting characteristic of a lighting apparatus according to a second embodiment of the present invention, (the ratio of the total lumen values is 0.64).

FIG. 3 shows a perspective view of a light-emitting element and a driver unit.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

The present invention provides a lighting apparatus which enables the directional light-emitting source to achieve the effect of floodlight illumination which meets the requirements of the safety regulations by using a lumen value design of the light-emitting source.

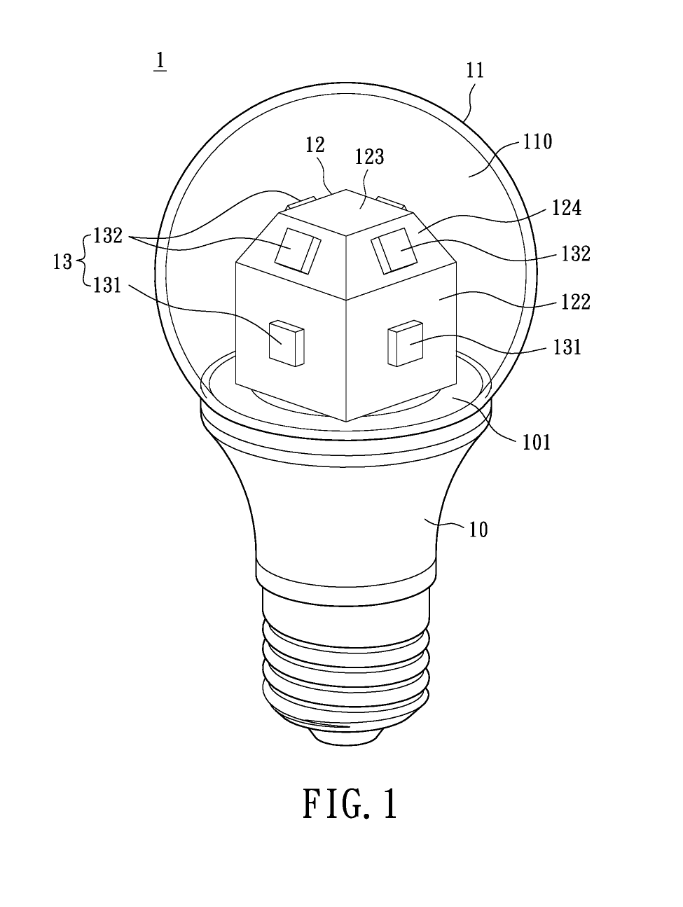

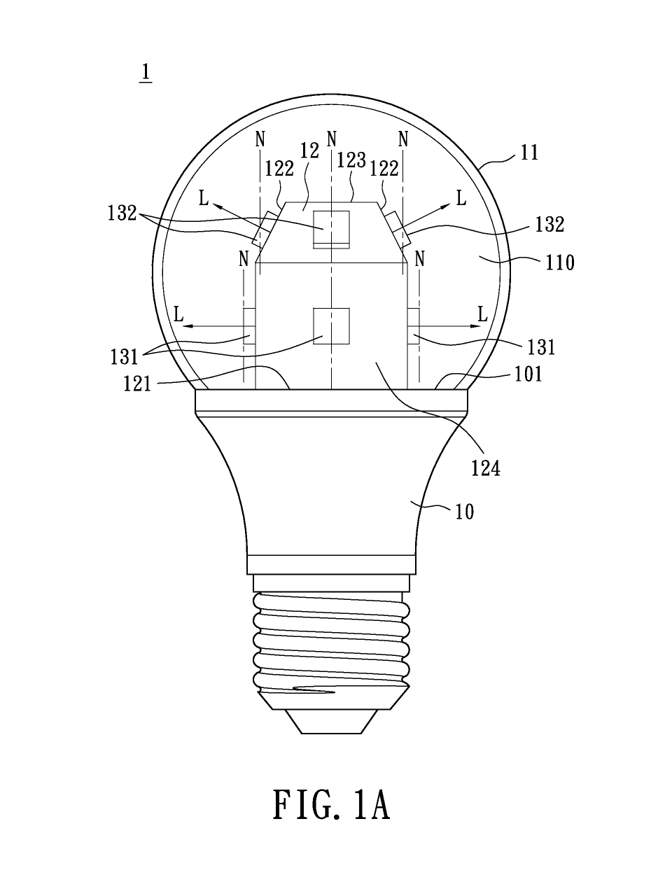

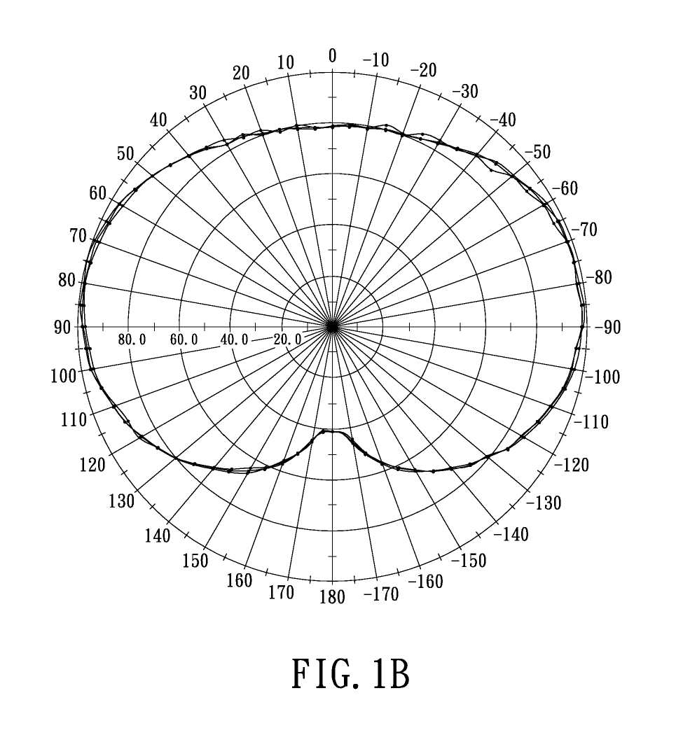

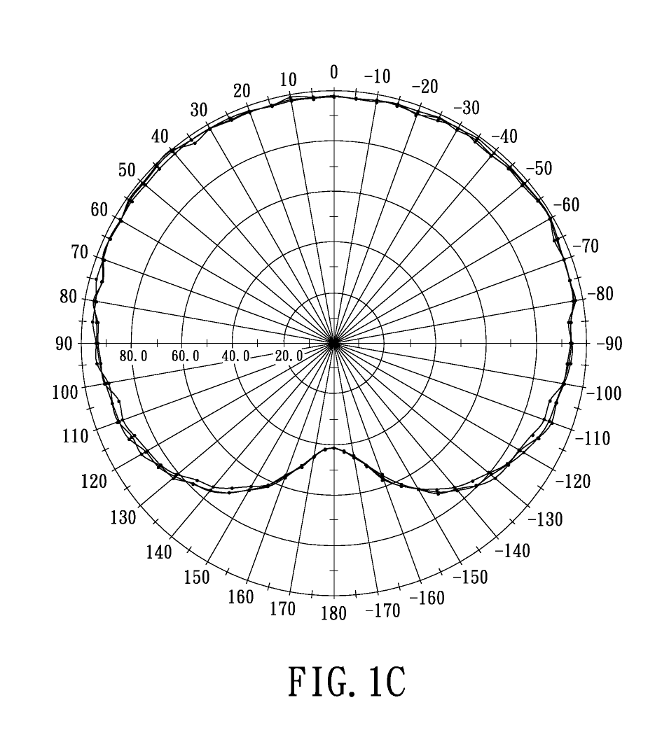

Referring to FIG. 1 & FIG. 1A, the first embodiment of the lighting apparatus of the present invention; wherein a lighting apparatus 1 of the present invention comprises at least a base 10, a transparent enclosure 11, a LED housing member 12 and a light-emitting unit 13. The LED housing member 12 including a bottom surface 121 is mounted on the base 10, a plurality of first side-mount surfaces 122 in connection with the bottom surface 121 and a plurality of second side-mount surfaces 124 in connection with the plurality of first side-mount surfaces 122, the light-emitting units 13 are mounted on the first side-mount surfaces 122 and the second side-mount surfaces 124; the light-emitting unit 13 includes at least two groups of light-emitting elements (referring to the plurality of first light-emitting elements 131 and the plurality of second light-emitting elements 132 described in the following), such as LED, diode modules or arrays etc., each group of the light-emitting elements has different lumen values, together they obtain a light-emitting pattern with the floodlight effect that meets the requirements of the safety regulations, for instance, at least 5% of the total lumen values is within the range 135 degree to 180 degree, or the luminous intensity (candelas) of the light source is distributed in the vertical plane of 0 degree, 45 degree and 90 degree, substantially in vertical symmetrical distribution etc., the aforementioned safety regulations will be tested in the embodiment described in the following.

In this embodiment, the coupling surface 101 is provided on the base 10 wherein the transparent enclosure 11 and the LED housing member 12 is mounted thereon; to be specific, the transparent enclosure 11 is a sheltering structure covering the coupling surface 101 to define a receiving space 110, for instance, the transparent enclosure 11 can be made of material approximated as a Lambertian scattering material or a Gaussian scattering material, or a material between the Lambertian scattering material and the Gaussian scattering material; the LED housing member 12 is disposed on the coupling surface 101 and received in the receiving space 110; the LED housing member 12 includes a bottom surface 121 coupled to the coupling surface 101 of the base 10, four first side-mount surfaces 122 in connection with the bottom surface 121 and four second side-mount surfaces 124 in connection with the first side-mount surfaces 122. In this embodiment, the LED housing member 12 is a pillar-like structure including a four-sided bottom surface 121, four first side-mount surfaces 122 and four second side-mount surfaces 124, the bottom surface 121 of the LED housing member 12 is in connection with the coupling surface 101 of the base 10 by means of sintering, gluing or mechanical fastening, the light-emitting units 13 is mounted on the four first side-mount surfaces 122 and the four second side-mount surfaces 124; in addition, the LED housing member 12 can enable better heat dissipation of the light-emitting unit 13.

In this embodiment, the light-emitting units 13 provide four first light-emitting elements 131 and four second light-emitting elements 132 which correspond to the first side-mount surfaces 122 and the second side-mount surfaces 124 respectively, the four first light-emitting elements 131 are mounted on the four first side-mount surfaces 122 of the LED housing member 12, in other words, each of the first side-mount surface 122 has a light-emitting element 131 mounted on it; likewise, each of the second side-mount surface 124 has also a second light-emitting element 132 mounted on it; furthermore, to obtain a better floodlight emitting effect, each of the first light-emitting element 131 and its corresponding second light-emitting elements 132 are arranged in the Normal direction N of the coupling surface 101, in other words, each of the first light-emitting element 131 is arranged below the corresponding second light-emitting element 132, the arrow L in the figure represents the direction of the optical axis of the light-emitting elements.

To further explain, the LED housing member 12 provides a top surface 123 with respect to the bottom surface 121, this implies that the top and the bottom of the LED housing member 12 are the top surface 123 and the bottom surface 121 respectively, also, the first light-emitting elements 131 and the second light-emitting elements 132 are not arranged on the top surface 123 (referring that no light-emitting elements are arranged on the top surface 123).

In the present invention, the total lumen values of the first light-emitting elements 131 can be greater or equal to that of the second light-emitting elements 132, for instance, the total lumen values of the second light-emitting elements and the first light-emitting elements can be adjusted to a ratio between 0.5 to 1, so as to obtain a light-emitting pattern with the floodlight effect, and meet the requirements of the safety regulations.

FIG. 1B shows a test diagram of the light-emitting characteristic of the lighting apparatus of the first embodiment wherein the ratio of the total lumen values of the second light-emitting elements 132 and the first light-emitting elements is 0.78, and the transparent enclosure 11 is made from a material approximated as a Lambertian scattering material; FIG. 1C shows a test diagram of the light-emitting characteristic of the lighting apparatus of the first embodiment wherein the ratio of the total lumen values of the second light-emitting elements 132 and the first light-emitting elements is 0.64, and the transparent enclosure 11 is made from a material approximated as a Gaussian scattering material; based on the embodiment shown in the figures, the light source has at least 5% of the total lumen values within the range 135 degree to 180 degree (the total lumen values is approximately 16% in this embodiment), and the luminous intensity (candelas) of the light source is distributed in the vertical plane of 0 degree, 45 degree and 90 degree, substantially in vertical symmetrical distribution, and the luminous intensity of the light source within 0 degree to 135 degree (symmetrical vertical axis) is substantially smoothly distributed, and the average values of the luminous intensity of any angle within 0 degree to 135 degree and the luminous intensity within 0 degree to 135 degree is not more/less than 20% of the requirements of the safety regulations.

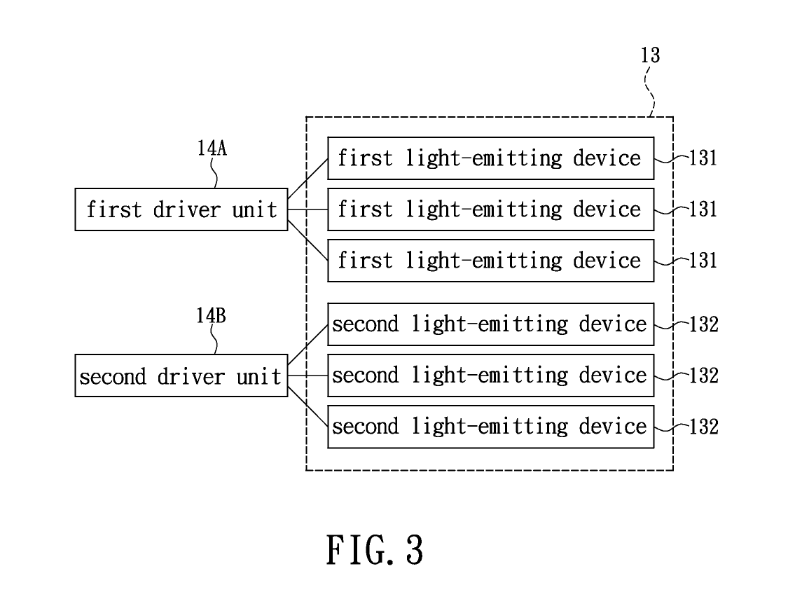

To further explain, the total lumen values of the second light-emitting elements 132 and the first light-emitting elements 131 can be controlled by using different control circuits to adjust the LED. For instance, the present invention make use of two groups of driver units to output different electric currents, as shown in FIG. 3, the first driver unit 14A can be connected electrically to the first light-emitting elements 131 while the second driver unit 14B can be connected electrically to the second light-emitting elements 132 (note that the amount of the first light-emitting elements 131 and the second light-emitting elements 132 shown in FIG. 3 are only for reference), the ratio of the electric currents outputted by the second driver unit and the first driver unit is within 0.5 to 1, for instance, the ratio of the electric currents is 0.78 or 0.64 etc., so as to control the total lumen values outputted by the LED.

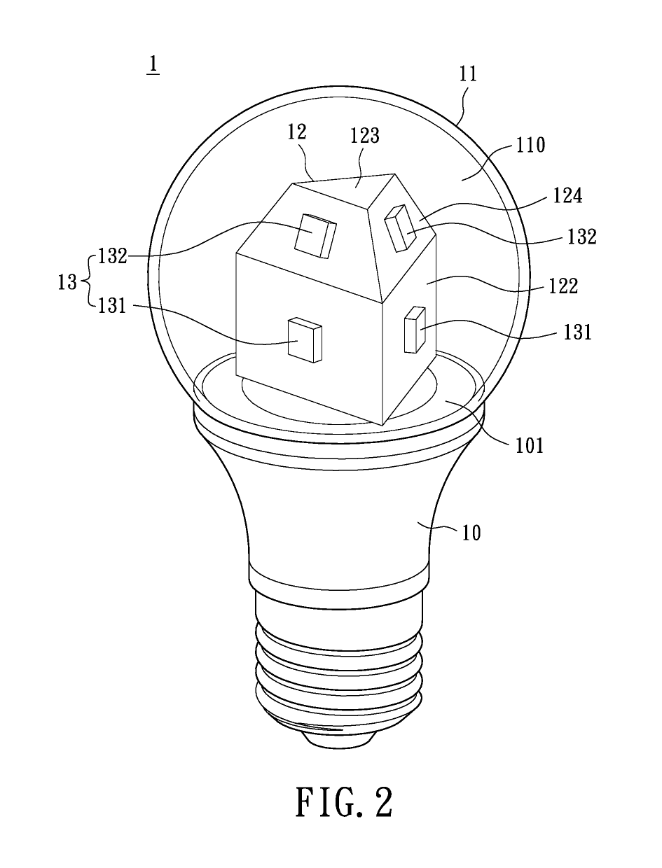

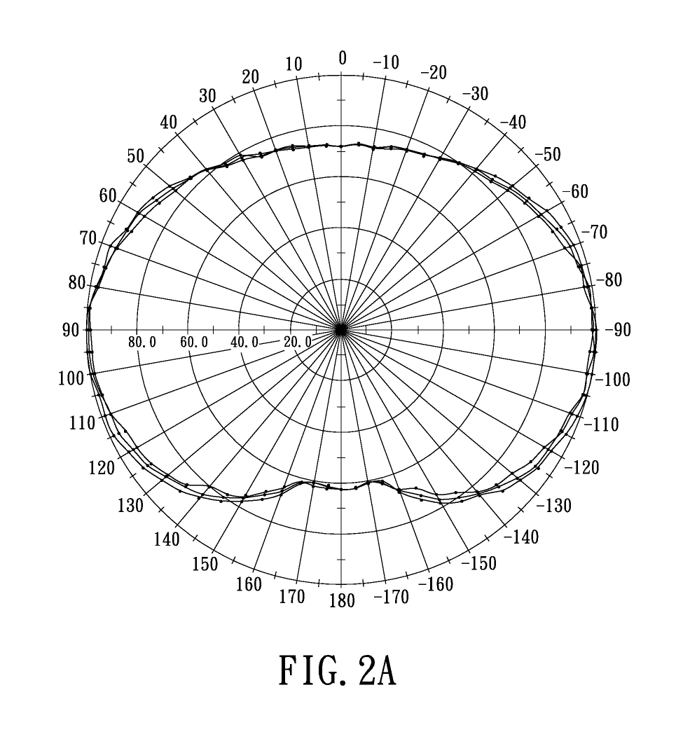

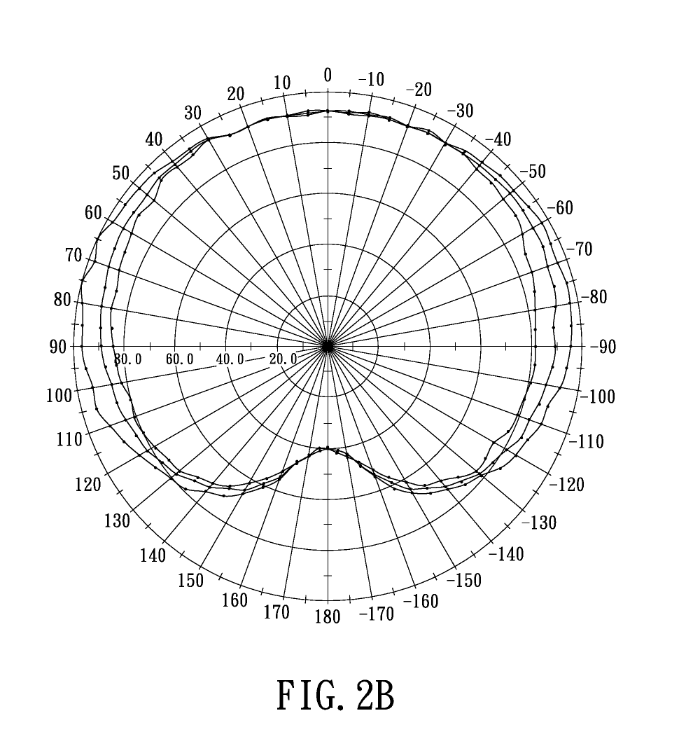

The second embodiment of the present invention is shown in FIG. 2, unlike the first embodiment, the second embodiment has a LED housing member 12, formed from a triangular bottom surface 121, three first side-mount surfaces 122 and three second side-mount surfaces 124. The light-emitting units 13 has three first light-emitting elements 131 and three second light-emitting elements 132 corresponding to the first side-mount surfaces 122 and the second side-mount surfaces 124, the three first light-emitting elements 131 is mounted on the three first side-mount surfaces 122 of the LED housing member 12, in other words, a first light-emitting element 131 is mounted on each of the first side-mount surface 122, likewise, a second light-emitting elements 132 is mounted on each of the second side-mount surface 124; furthermore, to obtain a better floodlight emitting effect, each of the first light-emitting element 131 is arranged below the corresponding second light-emitting element 132.

The second embodiment can also adjust electric currents to the total lumen values of the second light-emitting elements and the first light-emitting elements to a ratio within 0.5 to 1, so as to obtain a light-emitting pattern with floodlight effect and meet the requirements of the safety regulations.

FIG. 2A shows a test diagram of the light-emitting characteristic of the lighting apparatus of the second embodiment wherein the ratio of the total lumen values of the second light-emitting elements 132 and the first light-emitting elements is 0.78, and the transparent enclosure 11 is made from a material approximated as a Lambertian scattering material (i.e., the material provides a Lambertian scattering or nearly Lambertian scattering lights); FIG. 2B shows a test diagram of the light-emitting characteristic of the lighting apparatus of the second embodiment wherein the ratio of the total lumen values of the second light-emitting elements 132 and the first light-emitting elements is 0.64, and the transparent enclosure 11 is made from a material approximated as a Gaussian scattering material (i.e., the material has a Gaussian scattering features); based on the embodiment shown in the figures, the light source has at least 5% of the total lumen values within the range 135 degree to 180 degree (the total lumen values is approximately 16% in this embodiment), and the luminous intensity (candelas) of the light source is distributed in the vertical plane of 0 degree, 45 degree and 90 degree, substantially in vertical symmetrical distribution, and the luminous intensity of the light source within 0 degree to 135 degree (vertical symmetrically axis) is substantially smoothly distributed, and the average value of the luminous intensity of any angle within 0 degree to 135 degree and the luminous intensity within 0 degree to 135 degree is not more/less than 20% of the requirements of the safety regulations.

The present invention has at least the following advantages:

Firstly, the present invention can solve the problem of uneven illumination of the light due to directional light sources. In other words, the present invention utilizes the control method to adjust the lumen values so as to achieve the object of floodlight illumination from directional light sources.

Secondly, the lighting apparatus of the present invention can meet the requirements of the safety regulations, therefore owning a higher economic value.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A lighting apparatus comprising:
a base having a coupling surface;
a transparent enclosure mounted on the coupling surface defining a receiving space;
a multi-directional LED housing member disposed on the coupling surface and received in the receiving space, the LED housing member including a bottom surface coupled to the coupling surface, a plurality of first side-mount surfaces in connection with the bottom surface, and a plurality of second side-mount surfaces in connection with the plurality of first side-mount surfaces in a non-coplanar fashion;
a light-emitting unit including a plurality of first light-emitting elements respectively mounted on the first side-mount surfaces and a plurality of second light-emitting elements respectively mounted on the second side-mount surfaces,
wherein the total lumen values of the first light-emitting elements is greater than or equal to that of the second light-emitting elements.

2. The lighting apparatus according to claim 1, wherein the ratio of the total lumen values of the second light-emitting elements and the first light-emitting elements is within 0.5 to 1.

3. The lighting apparatus according to claim 2, wherein the LED housing member provides three first side-mount surfaces and three second side-mount surfaces.

4. The lighting apparatus according to claim 3, wherein each of the first side-mount surface has a first light-emitting element mounted thereon, and each of the second side-mount surface has a second light-emitting element mounted thereon; each of the first light-emitting element is arranged in a normal direction of the coupling surface with the corresponding second light-emitting element; this enables each of the first light-emitting element to be arranged below the corresponding second lighting device.

5. The lighting apparatus according to claim 2, wherein the LED housing member provides four first side-mount surfaces and four second side-mount surfaces.

6. The lighting apparatus according to claim 5, wherein each of the first side-mount surface has a first light-emitting element mounted thereon, and each of the second side-mount surface has a second light-emitting element mounted thereon; each of the first light-emitting element is arranged in a normal direction of the coupling surface with the corresponding second light-emitting element; this enables each of the first light-emitting element to be arranged below the corresponding second lighting device.

7. The lighting apparatus according to claim 6, wherein the LED housing member further comprising a top surface with respect to the bottom surface, wherein the first light-emitting elements and the second light-emitting elements are not arranged on the top surface.

8. The lighting apparatus according to claim 4, wherein the LED housing member further comprising a top surface with respect to the bottom surface, wherein the first light-emitting elements and the second light-emitting elements are not arranged on the top surface.

9. The lighting apparatus according to claim 1, wherein the transparent enclosure is made of a material approximated as a Lambertian scattering material or a Gaussian scattering material, or a material between the Lambertian scattering material and the Gaussian scattering material.

10. The lighting apparatus according to claim 1, wherein a first driver unit is connected electrically to the first light-emitting elements and a second driver unit is connected electrically to the second light-emitting elements.

11. The lighting apparatus according to claim 10, wherein the ratio of the electric current outputted by the second driver unit and the first driver unit is within 0.5 to 1.
